(19) United States
(12) Patent Application Publication
(10) Pub. No.: US 2026/0316584 A1
(43) Pub. Date: Oct. 15, 2026

(54) FLEET AND TROLLEY SYSTEM FOR MACHINES

(71) Applicant: Caterpillar Inc., Peoria, IL (US)

(72) Inventors: Russell A. Brockhurst, Carindale (AU); Cameron Thomas Lane, Oro Valley, AZ (US); Stefan Jacob Wulf, Washington, IL (US)

(73) Assignee: Caterpiller Inc., Peoria, IL (US)

(21) Appl. No.: 19/679,401

(22) Filed: May 15, 2026

Related U.S. Application Data
(63) Continuation-in-part of application No. PCT/US2023/080406, filed on Nov. 17, 2023.

(51) Int. Cl. B60L 5/38; B60L 53/62; B60M 7/00

(52) U.S. Cl. CPC B60L 5/38; B60L 53/62; B60M 7/003; B60L 2200/44

(57) ABSTRACT

This disclosure describes, in part, systems and methods for charging and delivering power to work machines such as machines traveling along a trolley system. The systems and methods provide for a continuous throughput of material and/or machines along the trolley system. The trolley system and controller of the system may be used to cause the work machines to travel at a speed to maximize a throughput rate of the trolley system by causing multiple work machines to share distribution of power to drive propulsion devices and to charge batteries of the work machines selectively to maintain the throughput rate of the trolley system.

### CROSS-REFERENCE TO RELATED APPLICATIONS

This application is a bypass continuation-in-part of PCT Application No. PCT/US2023/080406, filed Nov. 17, 2023, the entire contents of which are hereby incorporated by reference.

### TECHNICAL FIELD

The present disclosure relates generally to systems and methods for dispatching machines, and more particularly, to systems and methods for dispatching haul trucks between loading and unloading areas in a surface mining operation.

### BACKGROUND

Certain applications, such as strip mining, involve the transportation of aggregate material, such as ore, from a mining site to a processing or shipping facility. Typical mining operations use guided haul trucks that carry the extracted material from an extraction area or material source to a deposition area or a material sink. A typical large scale mining operation may include more than one material source and more than one material sink. The haul trucks used to transport the material may be autonomously guided, e.g., operate without a driver, and may perform hundreds of trips daily as some mining operations operate around the clock. The loading of the aggregate material onto the haul trucks is typically accomplished by use of wheeled loaders or excavators, material conveyors, shovels, and the like.

For many large commercial mining operations, maximization of equipment utilization is desired to maximize profit. The maximization of equipment utilization, especially in the case of autonomously guided machines, requires efficient dispatching of the haul trucks to the various loading and unloading stations. Various methods have been proposed in the past to optimize haul truck dispatching. For example, manual dispatch may be used to direct the haul trucks to the most efficient task at any given time. As can be appreciated, however, manual dispatch may not be as efficient as an automated task that performs the same function.

Another type of dispatch is a so-called “restricted” automatic dispatch, in which haul trucks are dispatched automatically based on restrictions defined by controllers of the mining site. Such controllers may include rules or limitations on haul truck assignments such as limiting a specific truck to a specific loading tool or dump site. If such limitations are removed, automatic dispatch can be used in which haul trucks are dispatched automatically to maximize production within the constraints of a daily production plan.

While the manual dispatch of trucks may be used effectively at small mine sites, complexity increases dramatically with mine site size making the manual dispatch of haul trucks for large sites impractical. Restricted Automatic Dispatch can be used effectively at larger mine sites provided that mine site controllers are vigilant and continuously manage the restrictions to optimize production. An example solution is to move to fully Automatic Dispatch so that mine operations may be optimized without the need for continuous intervention by controllers applying rules to the dispatch.

An example of an automatic dispatch system is described in United States Publication 2009/0327011 to Petroff (hereinafter “Petroff”). Petroff describes that “. . . the optimum schedule defining the number of trips taken along paths between the destination locations and the source locations H achieve the optimum production;”

However, while these existing and previously proposed solutions are more effective than manual dispatch in increasing production rates at a mine, these systems are not configured to maintain or optimize a trolley system for a throughput rate or material flow rate, or to balance power draw requirements among various machines as well as between providing propulsion and charging batteries of the battery powered machines. As a result, efficiency is hindered, fuel and other resource usage is increased, battery life is shortened, and output of the trolley system is reduced.

Examples of the present disclosure are directed toward overcoming the deficiencies described above.

### SUMMARY

In some examples, one general aspect includes a system for a trolley network configured to connect to and supply electric power to one or more work machines, the trolley network including: a first terminus; a second terminus; and a contact line. The system also includes a zero-emission work machine configured to intermittently connect to and draw electric power from the trolley network, the work machine including: a rechargeable battery, one or more propulsion devices, and a trolley interface apparatus. The system also includes a controller in operative communication with the work machine, the controller configured to: determine a throughput rate for the zero-emission work machine along the trolley network, determine a power draw by the work machine from the trolley network based at least in part on the throughput rate, and determine a distribution of the power draw between charging of the rechargeable battery and driving the one or more propulsion devices based at least in part on the power draw. Other examples of this aspect include corresponding computer systems, apparatus, and computer programs recorded on one or more computer storage devices, each configured to perform the actions of the controller.

In some examples, a method may include determining a throughput rate for a trolley system, the trolley system may include: a plurality of work machines, a plurality of terminals along a route for the plurality of work machines, a contact line for providing electrical power to the plurality of work machines. The method further includes determining a number of work machines connected to the trolley system. The method also includes determining a power draw requirement for a work machine based at least in part on the throughput rate. The method also includes determining a power availability on the trolley system for providing to the plurality of work machines. The method also includes determining a distribution of power for the plurality of work machines based at least in part on the power draw requirement for the work machine. The method also includes controlling delivery of the distribution of power through the plurality of terminals and the contact line. Other examples of this aspect include corresponding computer systems, apparatus, and computer programs recorded on one or more computer storage devices, each configured to perform the actions of the methods.

In some examples, one general aspect may include a system for managing work machines. The system also includes a trolley network configured to connect to and supply electric power to one or more work machines, the trolley network including: a first terminus, a second terminus, and a contact line connected to the first terminus and the second terminus and configured to enable a physical connection and an electrical connection to a work machine. The system also includes a controller in operative communication with one or more work machines, the controller may include: one or more processors and one or more non-transitory computer-readable media having instructions stored thereon that, when executed by the one or more processors, cause the one or more processors to perform various operations. The operations may include to determine a throughput rate for the trolley network, determine a number of work machines physically coupled to the trolley network, determine power draw requirements for the work machines, determine power availability on the trolley network through the contact line, determine a distribution of power to the work machines based at least in part on the power draw requirements and the power availability, and control delivery of the distribution of power through the contact line. Other examples of this aspect include corresponding computer systems, apparatus, and computer programs recorded on one or more computer storage devices, each configured to perform the actions of the controller.

### BRIEF DESCRIPTION OF FIGURES

The detailed description is set forth with reference to the accompanying figures. The use of the same reference numbers in different figures indicates similar or identical items or features.

FIG. 1 illustrates a work machine as part of a fleet and trolley system, according to at least one example.

FIG. 2 illustrates a schematic of a fleet and trolley system, according to at least one example.

FIG. 3 illustrates a diagram of a trolley network, according to at least one example.

FIG. 4 illustrates a flowchart depicting a method of charging a work machine via a trolley network, according to at least one example.

FIG. 5 illustrates a flowchart depicting a method of charging a fleet of work machines via a trolley network, according to at least one example.

FIG. 6 illustrates a flowchart depicting a method for controlling power delivery and usage for a fleet of work machines via a trolley network, according to at least one example.

FIG. 7 illustrates a flowchart depicting a method for controlling power delivery to one or more work machines and sharing available power to maintain a throughput rate of the trolley network, according to at least one example.

FIG. 8 illustrates an operating environment of a DET system, according to at least one example.

### DETAILED DESCRIPTION

Wherever possible, the same reference numbers will be used throughout the drawings to refer to the same or like parts.

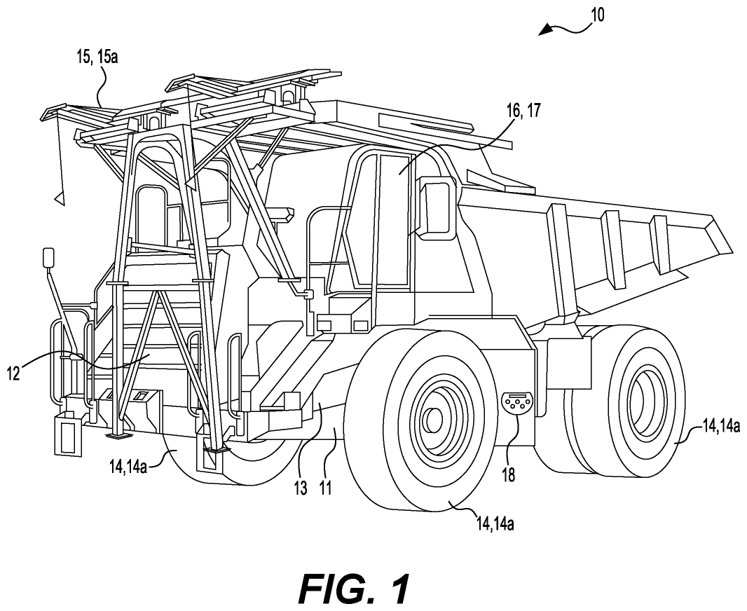

Referring now to the drawings and with specific reference to FIG. 1, a diagram of a work machine 10 according to some examples is depicted. While the work machine 10 is depicted as a large mining truck, it may alternatively be an excavator, front loader, motor grader, bulldozer, or comparable machine employed in mining, earth moving, construction, and/or agricultural applications. The work machine 10 may comprise a frame 11, a rechargeable battery 12, one or more propulsion motors 13, a tractive device 14, a charging apparatus 15, a positioning module 16, and a first communication module 17.

The work machine 10 may be a zero-emission machine. In an example, the work machine 10 may be a battery electric machine 10a being powered exclusively by the rechargeable battery 12 and driven by the one or more propulsion motors 13 (when disconnected from external power sources). The rechargeable battery 12 may be a lead-acid battery, a lithium-ion battery, or a nickel metal hydride battery; or may employ another battery chemistry and/or topology common to the art. In an example, the rechargeable battery 12 may be charged through a machine inlet 18. The machine inlet 18 may interface with a standard connector, such as one defined by IEC 62196 standards; or the machine inlet 18 may require a proprietary connector, depending on specific applicational requirements. Moreover, the rechargeable battery 12 may be charged through the charging apparatus 15 while the work machine 10 is connected to a trolley network 20, which will be discussed in greater detail below.

The one or more propulsion motors 13 may be traction motors in the form of DC series motors, AC series motors, AC induction motors, or synchronous motors; or may employ other common motor designs for converting electric power to mechanical torque. No limitation is intended herein for the number or specification of the propulsion motors 13, which may depend on the tractive device 14 and the operational requirements of the work machine 10. The work machine 10 may also comprise a powertrain for transferring electrical power from the rechargeable battery 12 (or from external sources) to the propulsion motors 13. Finally, the tractive device 14 may include the wheels and tractive devices 14 a as shown, or may employ alternative equipment, such as tracks, treads, and the like, in order to propel the work machine 10.

In another example, the work machine 10 may be a fuel cell electric machine 10b, such as a hydrogen-powered machine, being powered exclusively by a fuel cell and the rechargeable battery 12 (when disconnected from external power sources). In such examples, the fuel cell may be the primary power source for driving the propulsion motors 13, while the rechargeable battery 12 may be configured to provide starter power to the fuel cell, capture energy from regenerative braking, supply supplemental power during high-performance applications, and/or power accessories of the work machine 10, among other possibilities. Similar to the battery electric machine 10a, the fuel cell electric machine 10b, and more specifically the rechargeable battery 12 of the fuel cell electric machine 10b, may be charged by the trolley network 20 through the charging apparatus 15, but may require different power allocations and management strategies, which will be discussed in greater detail below.

The positioning module 16 may be configured to identify a location of the work machine 10, which may be communicated to a controller 30 or a fleet controller 30a, which will be discussed in greater detail below. In particular, the positioning module 16 may be a global positioning system, such as a global navigation satellite system, the eponymous Global Positioning System (GPS), or employ comparable technologies such as a Global Navigation Satellite System (GNSS). In other examples, the positioning module 16 may be a local positioning system, such as one employing cellular base stations, radio broadcast towers, time of flight technology, trilateration techniques, optical trackers, and yet other possibilities. The positioning module 16 may be configured to relate a distance between the work machine 10 and the trolley network 20 and/or assist in navigating the work machine 10 to the trolley network 20 and other key locations.

The first communication module 17 may be configured to communicate a plurality of states of the work machine 10, including the aforementioned location, to the controller 30 or the fleet controller 30a. In various examples, the first communication module 17 may employ short-range or medium-range wireless communication protocols; may employ Wi-Fi, Bluetooth, cellular, and/or radio technologies; and/or may utilize other communication technologies common to the art. In an example, the first communication module 17 may enable bi-directional communication with the controller or fleet controller 30a. More specifically, the work machine 10 may relay the plurality of states to the controller 30 and/or the fleet controller 30a and may receive instructions from the controller 30 and/or the fleet controller 30a for scheduling, navigating to, connecting to, and drawing power from the trolley network 20.

The work machine 10 may be part of a system configured to meet particular requirements of a production plan and meet specific production targets over time or over a batch size. The system may not attempt to manage the sequence or arrival times for individual work machines 10 according to a schedule. Instead, the production plan may be expressed in terms of a throughput rate or flow rate, as described herein. The throughput rate or flow rate may be expressed as a flow rate of work machines and/or material and may comply with particular limitations such as a loading rate at a loading machine, travel speed and/or time, and delivery or dump rate. The throughput rate may include a number of work machines 10 on the trolley system at any given time. The throughput rate may include a probabilistic distribution that may indicate how often there may be more or less than a target average number of work machines 10 on the system 1. The number of work machines 10 on the system 1, as defined for the throughput rate may include the average number of work machines 10 coupled to the system at any particular point in time. The throughput rate may be associated with a distribution such that the system 1 is considered to be at or within a specified throughput rate when the system 1 is operating with a throughput rate (e.g., number of work machines 10) that is within one standard deviation of the average (e.g., target average). In some examples, the system 1 may be within two standard deviations of the target average of the throughput rate (e.g., number of work machines 10). In this manner, the target throughput rate may include the target number of work machines 10 connected to the system 1 as well as a range above and below the target number.

The throughput rate may be determined over a time period (e.g., over a day, window of several hours, weeks, etc.) for a particular production circuit. The production circuits may be managed such that controlling the number of work machines 10 and/or the throughput rate and/or the speed of the work machines (e.g., power draw) enables the production circuit to meet targets for the particular production circuit.

A controller 30 of the system may determine machine assignments based on the average time or throughput associated with defined activities. For Battery Electric Machines (BEM), the energy use and battery damage associated with activities may also considered. From an assignment perspective, the trolley represents an activity that involves travel and charging. In some examples, the controller 30 may manage the system to achieve either consistent travel times or throughput. The system 1 may also manage work machines 10 that are powered by diesel, diesel electric, fuel cell, and other such fuel and power sources. Such work machines 10 may not draw power from the trolley system and may therefore enable the controller 30 to direct additional energy and resources to other BEMs on the trolley system. In some examples, the diesel electric machines, fuel cell machines, and other such work machines may travel along the trolley network without drawing power by from the trolley system. In some examples, the work machines may use a combination of power from the trolley system and the on-board fuel systems (such as a fuel cell system).

The controller 30 may manage the work machines 10 of the system 1 such that the target number of work machines 10 on the system (e.g., connected to the trolley system) is maintained within the range described above. The controller 30 may manage the work machines 10 based on this throughput rate rather than based on a schedule. The controller 30 may therefore manage the system 1 such that the total power draw and throughput is constant (or constant within a threshold variation above and below). The controller 30 may manage the system 1 to increase the speed of the work machines 10 on the trolley such that the work machines 10 draw and consume power to enable the work machines 10 to travel at maximum speeds (within defined speed limits).

In one example, the work machines 10 may adjust their power draw from the trolley to minimize battery damage. To reduce the battery damage, the work machines may independently adjust their power draw from the trolley within voltage limits. A target voltage and a lower voltage limit may be used to identify operating conditions to minimize battery damage. The work machines may monitor the voltage on the trolley and gradually reduce their speed (e.g., to a lower speed threshold that may be set) such that the voltage on the trolley falls below the target level. As additional work machines 10 connect to the trolley, the work machines 10 may gradually increase their power draw so long as the voltage level remains above the lower voltage limit. The available power used by the work machines 10 connected to the trolley may be adjusted to enable the work machines to draw power for propulsion without requiring inter-vehicle communications and/or communications with a central office.

In one example, the work machines 10 may be managed on the trolley network 20 to achieve consistent travel times regardless of the number of work machines 10 connected to the trolley network 20. The controller 30 may cause the system 1 and/or work machines 10 to operate such that the work machines 10 may travel as fast as allowed (subject to interactions with other machines and defined speed limits). In this example, each work machine 10 connecting to the trolley network 20 may draw as much power as possible for propulsion (power a drive motor) and to charge a rechargeable battery of the work machine. Once the work machine 10 reaches its target discharge capacity (e.g., battery status), the power draw from the trolley network 20 may be reduced to the level required to only power propulsion of the work machine 10. When a work machine physically connects to the trolley network 20 and finds that no additional power is available, the work machine 10 may use battery power to travel as fast as allowed. When additional power becomes available (e.g., after a work machine 10 finishes charging, or a work machine 10 exits the trolley network 20), the work machine 10 may start to draw as much power as it can to power propulsion and to charge. In some examples, the work machines 10 may communicate with one another over a network and/or directly using a machine-to-machine communication system to cause power delivery balancing based on needs of various work machines 10. For example, a first work machine and a second work machine may communicate with one another to determine power balancing, for example in the event that the second work machine has a nearly depleted battery, the power delivery through the trolley network 20 to the work machines may re-balance to provide prioritized charging to the second work machine, even if the first work machine was previously connected to the trolley network 20. The determination that power is available on the trolley network 20 may be made by the BEM (by sensing voltage or other attributes of the trolley network) or by a controller (e.g., at a main office) or by computing devices on-board or associated with the work machines 10 that may communicate with other work machines 10. As a variation to this example, the amount of power used by work machines 10 to charge may be reduced as more work machines 10 connect so that more work machines 10 can use the trolley network 20 power for propulsion.

The system 1 and the controller 30 may be configured to optimize productivity by keeping all work machines 10 travelling as fast as allowed, and may simplify dispatch of work machines 10 by maintaining a consistent average travel time for all work machines 10 on the trolley network 20 as described herein.

In some examples, the trolley network 20 may be used in areas with no network coverage (e.g., no connection to a remote system and/or to other work machines 10). In such examples, individual work machines 10 may sense if power is available on the trolley network 20 by sensing voltage or other attributes of the trolley network 20. The work machines 10 may then have their own controllers and/or computing systems that may be used to make independent power decisions such as when to charge and when to operate on battery power even though connected to the trolley network 20.

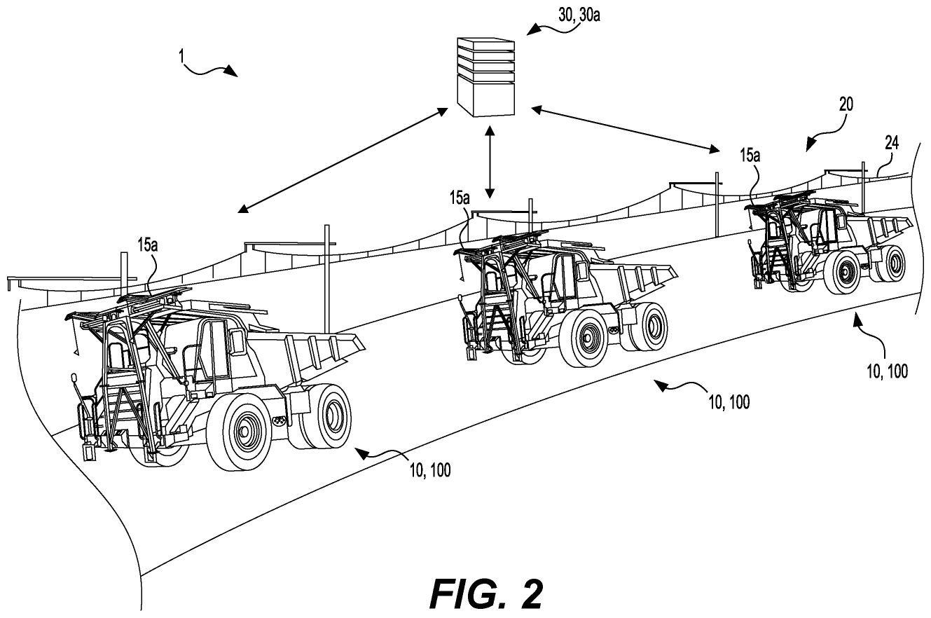

Turning now to FIG. 2, a diagram of a fleet and trolley system is generally referred to as system 1. The system 1 may comprise the work machine 10, a trolley network 20, and a controller 30. In an example, the system 1 may further comprise a plurality of zero-emission work machines and the controller 30 may further include the fleet controller 30a. Each work machine 10 may be configured to intermittently connect to and draw electric power from the trolley network 20. The work machines 10 may include zero-emission work machines and additional zero-emission work machines in addition to one or more individual work machines. Likewise, the trolley network 20 may be configured to connect to and supply electric power to one or more work machines 10 concurrently; and may supply power to each of the plurality of work machines 10 over time.

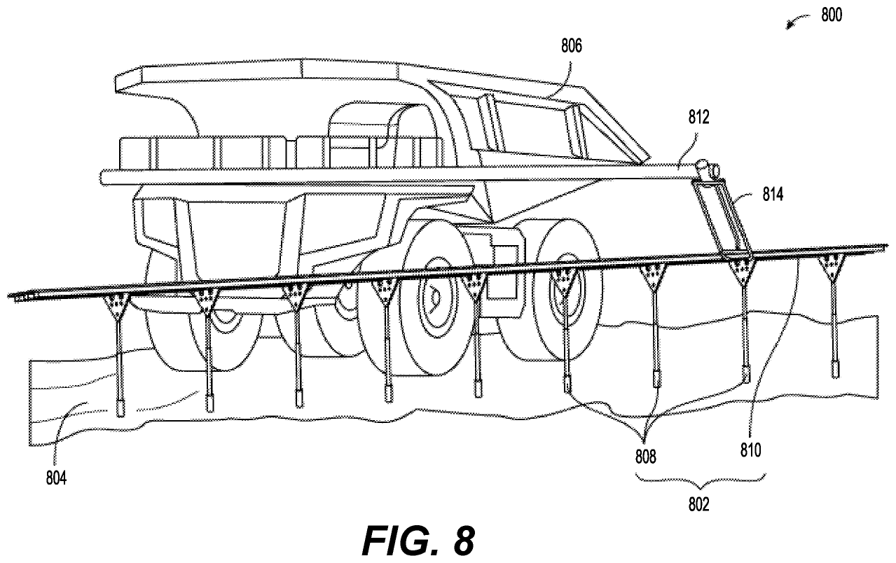

The system 1 may be an example of a trolley system that allows for Battery Electric Machines (BEM) such as the work machine 10 to charge while travelling along the system 1. The system 1 may include a trolley network 20 with trolley stations that may include trolleys (overhead wires), We address this in the sentences below→side rails, electrified?? rails embedded in roads or other similar systems and configurations. In an embodiment, the trolley network 20 disclosed herein may comprise an electrified side rail that is disposed alongside a road to receive energy from a power source (electric grid network, a solar farm, a wind farm or any other source) via a power module (power converters, grid controllers and other types of devices for rendering output power suitable for use by the work machine 10) and the work machine's on-board power transfer system that may include an arm extendable laterally from the work machine 10 to contact the side rail and receive power from the power module via the side rail and to subsequently transfer the received power to the machine's powertrain, for example as shown and described herein, including for example at FIG. 8

An electrified rail system deployed along the side of a haul road including both straight and curved sections, for example as shown in FIG. 8. Electric drive machines may connect to the side rail using an extendable side arm. While connected to the side rail, haul trucks are able to draw power to propel and to charge their batteries (if any). In many cases, machines drawing power from the side rail are able to travel faster than machines traveling under their own power.

Once a work machine 10 has successfully connected to the trolley network 20, the work machine 10 draws power which may be used for propulsion and/or charging. The trolley network 20 may have limitations with respect to the total amount of power that it can deliver to connected work machines 10. Where connected work machines 10 attempt to draw too much power, voltage levels fall, and machines are rejected (disconnected). Without effective management, trolley stations may reject up to 30% of the machines that attempt to connect. Accordingly, the systems and methods described herein provide for management of the power delivery through the trolley system to ensure that the work machines 10 maintain a desired throughput rate along the system 1. As described herein, the throughput rate may refer to a rate of machine progress (as an aggregate) along the system 1. For example, the throughput rate may refer to a number of machines reaching an end of the system 1 per unit time (e.g., minute, hour, etc.). The throughput rate may also refer to a mass flow rate of material conveyed along the system 1, such as material that may be carried by the work machines 10 based at least in part on the work machine capacity of the work machines.

As depicted, the system 1 may be modelled as a long narrow line with one entry point and one primary exit point. The system 1 may include a single series of lanes (or road segments) running parallel to the infrastructure of the system 1. The work machines 10 passing through the system 1 will use this single lane. Where the system 1 provides the only path available (e.g., climbing out of a pit), all work machines 10 may be required to travel through the station including diesel, diesel electric, battery electric machines and support machines.

The maximum energy drawn from the system 1 may be determined independently for each work machine 10. The work machines 10 may have a maximum amount or portion of energy used for propulsion (speed) and may also have a maximum amount or portion of energy used for charging. To target or cause the resulting charge for each work machine 10 falls within a target charge range (e.g., within a range defined by a minimum charge and a maximum charge) such that the work machine 10 may have charge for the next planned activity, the maximum charge and minimum charge of the range may also be set for each work machine 10. Where a work machine 10 is still connected to the system 1 when it reaches its target charge, the work machine 10 may stop charging and the energy used for propulsion may increase or the total energy used by that work machine 10 may be reduced and/or re-allocated to other work machines in the system 1. In some examples, a work machine 10 may reach the target charge range and may stop charging when it reaches the minimum end of the target range based on other conditions of the work machine (e.g., battery temperature rising) and/or based on potential impacts to productivity and/or throughout for the system. For examples, the work machine 10 may stop charging such that power may be distributed to other work machines that have yet to reach their target charge range. Based on different work assignments, work machine requirements, loading requirements, and power consumption across different work machines, the target charge range may vary between different work machines and may be customizable for each work machine 10.

The system 1 may be configured to meet particular requirements of a production plan and meet specific production targets over time or over a batch size. The system 1 does not attempt to manage the sequence or arrival times for individual work machines 10 according to a schedule. Instead, the production plan may be expressed in terms of a throughput rate or flow rate (e.g., an average number of work machines 10 connected to the trolley system XYZ), as described herein. The throughput rate or flow rate may be expressed as a flow rate of work machines and/or material and may comply with particular limitations such as a loading rate at a loading machine, travel speed and/or time, and delivery or dump rate.

A controller 30 of the system 1 may determine machine assignments based on the average time or throughput associated with defined activities. For Battery Electric Machines (BEM), the energy use and battery damage associated with activities may also considered. From an assignment perspective, the trolley represents an activity that involves travel and charging. In some examples, the controller 30 may manage the system 1 to achieve either consistent travel times or throughput.

In one example, the work machines 10 may be managed on the trolley network 20 to achieve consistent travel times regardless of the number of work machines 10 connected to the trolley network 20. The controller 30 may cause the system 1 and/or work machines 10 to operate such that the work machines 10 may travel as fast as allowed (subject to interactions with other machines and defined speed limits). In this example, each work machine 10 connecting to the trolley network 20 may draw as much power as possible for propulsion (power a drive motor) and to charge a rechargeable battery of the work machine. Once the work machine 10 reaches its target discharge capacity (e.g., battery status), the power draw from the trolley network 20 may be reduced to the level required to only power propulsion of the work machine 10. When a work machine physically connects to the trolley network 20 and finds that no additional power is available, the work machine 10 may use battery power to travel as fast as allowed. When additional power becomes available (e.g., after a work machine 10 finishes charging, or a work machine 10 exits the trolley network 20), the work machine 10 may start to draw as much power as it can to power propulsion and to charge. In some examples, the work machines 10 may communicate with one another over a network and/or directly using a machine-to-machine communication system to cause power delivery balancing based on needs of various work machines 10. For example, a first work machine and a second work machine may communicate with one another to determine power balancing, for example in the event that the second work machine has a nearly depleted battery, the power delivery through the trolley network 20 to the work machines may re-balance to provide prioritized charging to the second work machine, even if the first work machine was previously connected to the trolley network 20. The determination that power is available on the trolley network 20 may be made by the BEM (by sensing voltage or other attributes of the trolley network) or by a controller (e.g., at a main office) or by computing devices on-board or associated with the work machines 10 that may communicate with other work machines 10. As a variation to this example, the amount of power used by work machines 10 to charge may be reduced as more work machines 10 connect so that more work machines 10 can use the trolley network 20 power for propulsion.

The system 1 and the controller 30 may be configured to optimize productivity by keeping all work machines 10 travelling as fast as allowed, and may simplify dispatch of work machines 10 by maintaining a consistent average travel time for all work machines 10 on the trolley network 20 as described herein.

In some examples, the trolley network 20 may be used in areas with no network coverage (e.g., no connection to a remote system and/or to other work machines 10). In such examples, individual work machines 10 may sense if power is available on the trolley network 20 by sensing voltage or other attributes of the trolley network 20. The work machines 10 may then have their own controllers and/or computing systems that may be used to make independent power decisions such as when to charge and when to operate on battery power even though connected to the trolley network 20.

In some examples, the work machines 10 may be managed by the controller 30 or other control system to achieve a consistent throughput regardless of the number of work machines 10 connected to the trolley network. A controller 30 may allocate the available energy on a network trolley 20 across all connected work machines 10 based at least in part on factors such as machine size, machine performance, predicted energy use, current discharge capacity and target discharge capacity. Individual work machines 10 may draw power for charging in proportion to their speed (or other such factors such as energy consumption for one or more operations of the work machine 10) so that their total power draw is proportional to speed or other such factors. In this manner, as more work machines 10 connect to the network trolley 20, the power allocations for all connected work machines 10 may be reduced and all connected work machines 10 may travel slower. Where the speed of the work machines 10 is reduced in proportion to the number of work machines 10 connected to the network trolley 20, consistent throughput may be maintained (e.g., the same number of machines pass through the network trolley 20 per unit of time regardless of how many machines are connected). In some examples, the controller 30 may thereby reduce and/or minimize battery damage by reducing the use of battery power by connected work machines 10 and may simplify dispatch by maintaining a consistent throughput for the system 1.

In some examples, the work machines 10 may use machine-to-machine communications to adjust their power allocations. For example, where a first work machine drawing power catches up to a second work machine that is not drawing power, the first work machine and the second work machine may negotiate to reallocate the available power (e.g., share power draw, power usage, and battery status information such that the first work machine and the second work machine may determine a balance of propulsion and charging between the two work machines) so that both work machines travel faster (e.g., at least by causing the first work machine to travel faster). Alternatively, if a diesel or other non-electric powered work machine catches up to a BEM connected to a network trolley 20, the diesel machine may communicate with the BEM to cause the BEM to allocate more power to propulsion or to increase its power allocation by negotiating (e.g., communicating power information such that the BEMs may determine a balance of power provided to each of the BEMs and for the purposes of propulsion versus charging) with other BEMs connected to the network trolley 20. In some examples, such as a system that may include a BEM and a diesel-electric machine (or fuel cell machine), the diesel-electric machine may travel entirely on fuel without using battery power. Accordingly, the BEM and diesel-electric machine may negotiate for power sharing such that the diesel-electric machine may use diesel power and the trolley capacity may be used to power the BEM for power the propulsion system and/or charge the battery.

In an example, work machines 10 may be part of a fleet 100. The fleet 100 may include only zero-emission work machines, or it may further include one or more diesel-electric machines (not shown) or other machines and machinery which are also capable of drawing electric power from the trolley network 20. Accordingly, the trolley network 20 may be configured to connect to and supply electric power to the one or more diesel-electric machines concurrently, which may or may not be concurrent with the usage by the work machines 10.

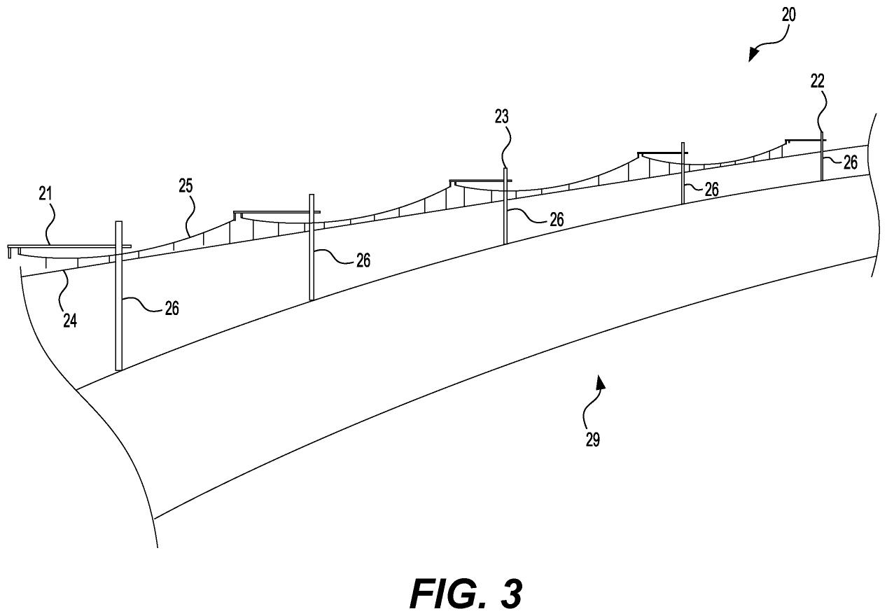

With reference now to FIG. 3, the trolley network 20 may include a first terminus 21 and a second terminus 22, which define a route 29 of the trolley network 20; and one or more contact lines 24 which span the route 29. In various examples, the trolley network 20 may be placed on an uphill segment of a mining site, a strategic route of a construction zone, or a harvesting path of a plantation. However, no limitation is intended herein for the placement, length, or elevation change exhibited by the trolley network 20. It is further worth noting that the trolley network 20 depicted in FIG. 3 is exemplary in nature, and is not intended to restrict the design or form of the trolley network 20.

In an example, a work machine 10 may enter or exit and/or connect to or disconnect from the trolley network 20 at either the first terminus 21 and/or the second terminus 22. Accordingly, any work machine 10 using the trolley network 20 to draw electric power may need to travel the route 29. In other examples, the trolley network 20 may further include one or more terminals 23 located along the route 29 between the first terminus 21 and the second terminus 22, wherein any work machine 10 may enter or exit and/or connect to or disconnect from the trolley network 20 at any terminus (such as the first terminus 21, second terminus 22, or other of the one or more terminals 23). And in yet other examples, a work machine may enter or exit and/or connect to or disconnect from the trolley network 20 at any point along the route 29 between the first terminus 21 and the second terminus 22. In some configurations, the trolley network 20 may operate in a single direction only, wherein an associated work machine 10 may only travel in a single direction along the route 29. And in other configurations, the trolley network 20 may operate bidirectionally and/or may include multiple lanes for parallel charging.

In an exemplary example, the contact lines 24 may include DC power lines and/or AC power lines operatively receiving electric power from a local substation (not shown). In the same or other examples, the contact lines 24 may be physically supported by one or more catenaries 25 of the trolley network 20. In turn, the catenaries 25 may be carried by support poles 26 placed at intervals across the route 29. In such configurations, the charging apparatus 15 of each work machine 10 may include an apparatus 15 such as a pantograph 15a configured to controllably draw current from the contact lines 24. For example, the pantograph 15a may be spring-loaded and drive one or more carbon brushes into contact with the power lines. It may be understood that the catenaries 25, contact lines 24, and charging apparatus 15 are designed to interface with one another, including considerations for machine height, connection type, current type, voltage and/or current levels, etc.

In other examples, other designs for the trolley network 20 are also possible and envisioned, such as but not limited to designs employing trolley poles, bow collectors, underbody collectors, and other forms of ‘live’ electricity transfer. For example, the trolley network 20 may alternatively include a ground-level power supply, wherein the one or more contact lines 24 may include conductive rails or tracks; and the charging apparatus 15 may include an underbody collector configured to interact therewith. And in other examples, the trolley network 20 may include non-contact conductors, such as those facilitating in-road inductive charging. Indeed, the contact lines 24 may embody any form of ‘live’ electricity supply and the associated charging apparatus 15 may embody any form of ‘live’ electricity receipt, depending on specific applicational requirements.

Referring again to FIG. 2, the controller 30 may be in operative bi-directional communication with a work machine 10. The controller 30 may be configured to manage a throughput rate of the trolley network 20, a flow rate of material, a power draw by the work machines 10 from the trolley network 20; and a machine level distribution of the power draw between charging the rechargeable battery 12 and driving the tractive device 14.

The controller 30 may be configured to adjust the power delivery to achieve a particular throughput rate and/or flow rate consistent with the energy available on the trolley network 20. Therefore, the work machines 10 connected to the trolley network 20 may travel under battery power, adjust speed, or otherwise adjust operations to maintain the predetermined and/or desired throughput rate.

In some examples, the connections between the work machine 10 and the trolley network includes a physical connection as well as an electrical connection. The physical connection may enable the work machine to connect electrically, however the mechanical connection may be made without forming an electrical connection. Accordingly, in some examples, the work machines may connect to the network trolley but may use battery power for driving the motor either instead of or in addition to power drawn from the trolley network 20.

In an example, the controller 30 may further include a fleet controller 30a in operative bi-directional communication with each work machine 10 within the fleet 100. Likewise, the fleet controller 30a may be configured to manage: a throughput of the trolley network 20, a flow rate of material, a power draw by each work machine 10 from the trolley network 20, and a machine level distribution of the power draw of each work machine 10 between charging the rechargeable battery 12 and driving the tractive device 14. In other words, the controller 30 may manage a work machine 10 and the fleet controller 30a may manage the fleet 100. In some examples, there may not be a central controller. Accordingly, the work machines 10 may operate independently without interaction with a central controller (e.g., an office). In such cases, there may not be a central controller available to allocate energy use for the work machines 10 using a trolley. The work machines may be able to interact with other work machines using the trolley and/or other communication channels (peer-to-peer communications). In some examples, even such communications may be limited due to the relatively long length of some trolley networks 20.

In some examples, the controller 30 may be included on the work machine 10, e.g., in the form of an onboard computer, an engine control unit, a battery management system, and the like. In the same or other examples, the work machine 10 may operate independently and may manage its own usage of the trolley network 20. In other examples, the controller 30 may be located external to the work machine 10 and may communicate with the work machine 10 through the first communication module 17.

In those examples comprising a fleet 100 of work machines 10, the fleet controller 30a may be located external to the fleet 100 and may communicate with each work machine 10 through the first communication module 17 of each work machine 10. Accordingly, each work machine 10 may not necessarily operate independently and may be centrally managed by the fleet controller 30a. In the same or other examples, the fleet controller 30a may be remotely located, e.g. in a management station; may be located on the trolley network 20, e.g. in the form of a control panel, a human-machine interface, an embedded computer, etc.; may be located on a work machine 10 within the fleet 100, e.g. in the form of an onboard computer, an engine control unit, a battery management system, etc. ; or may even be a distributed across each work machine 10 or diesel-electric machine 102 of the fleet 100, e.g. in the form of a distributed computer.

In an example, the fleet controller 30a may include at least a processor 31, a memory 32 in the form a non-transitory computer-readable medium, and a second communication module 33 enabling bi-directional communication with at least the first communication module 17.

With continued reference to FIG. 2, the controller 30 may monitor one or more states of the work machine 10, optimize for one or more predetermined criteria, control power delivery to a work machine 10 from the trolley network 20, control power usage by the work machine 10 (e.g., determining a first portion of power to use for driving the work machine 10 and a second portion of power to use for charging the battery), and manage the power usage of the trolley network 20 by the work machine 10.

More specifically, the controller 30 may monitor a type of the work machine 10, (e.g., the make, model, fuel type, powertrain, tractive device 14, etc.); a state of charge of the rechargeable battery 12; a location of the work machine 10; and one or more assigned tasks of the work machine 10. In some examples, the controller 30 may further monitor a state of health of the rechargeable battery 12; a priority of the assigned tasks; and yet other possible states, where no limitation is intended by the present disclosure. And in other examples where the work machine 10 is the fuel cell electric machine 10b, the controller 30 may monitor a fuel cell fuel level (e.g., a quantity or percentage of hydrogen gas remaining in the tank). Similarly, the fleet controller 30a may monitor the above states for each work machine 10 of the fleet 100. Furthermore, the controller 30 or fleet controller 30a may monitor one or more states of the trolley network 20, such as a count of the presently connected work machines 10, a power draw of each work machine 10 that is connected, and a saturation of the trolley network 20.

And in yet other examples, the controller 30 or fleet controller 30a may further monitor one or more diesel-electric machines and/or other machines and machinery associated with the trolley network 20. In such examples, the states of the trolley network 20 may include a count of the presently connected diesel-electric machines 102 (or other connected machines); and/or a power draw of the diesel-electric machine 102 (or other connected machines). Indeed, no limitation is intended herein for the type or number of states of the trolley network 20 being monitored by the controller 30 or fleet controller 30a.

In any of the examples described herein, the controller 30 may manage the work machine 10 by determining power delivery and power distribution across work machines based on a number of predetermined criteria, which may include, without limitation, an energy efficiency, a productivity, and/or a depreciation of the work machine 10. Likewise, the fleet controller 30a may manage one or more work machines 10 and/or the fleet 100 by optimizing for a number of predetermined criteria, which may include, without limitation, an energy efficiency, a productivity, and/or a depreciation of each work machine 10, one or more work machines 10, and/or the fleet 100 as a whole. Various management strategies dictating the usage of the trolley network 20 by each work machine 10 and/or the plurality of work machines 10 are discussed in greater detail below.

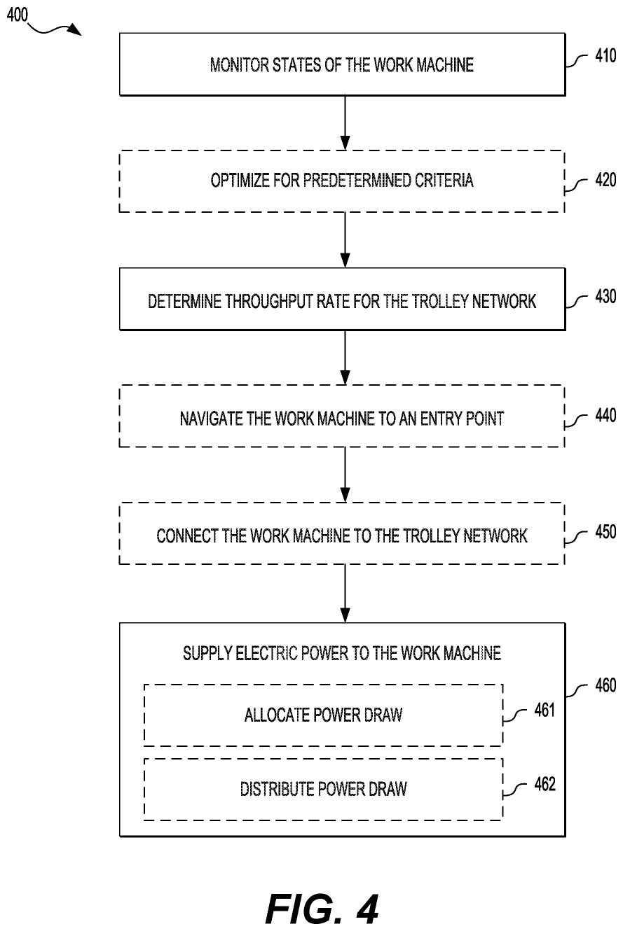

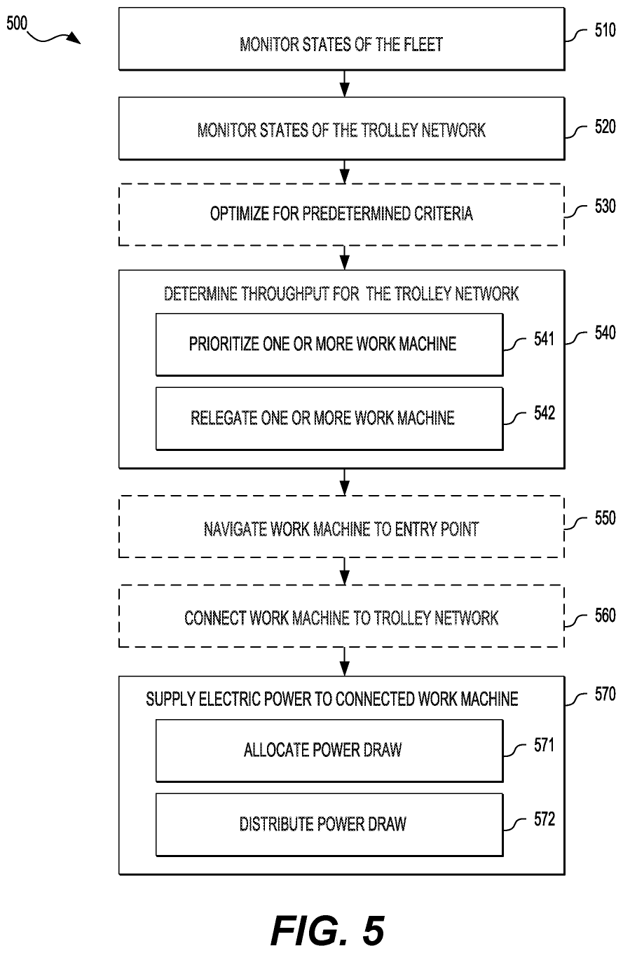

Turning now to FIG. 4, a method 400 of charging a work machine via a trolley network is depicted. It may be understood that the method 400 and FIG. 4 relate to a process of charging a single zero-emission work machine, while the method 500 and FIG. 5 relate to a process of charging a fleet of zero-emission work machines, which will be discussed further below. As seen in FIG. 4, the method 400 comprises monitoring a plurality of states of the work machine (e.g., at step 410); determining a throughput rate for the trolley network (e.g., at step 430); and supplying electric power from the trolley network to the work machine (e.g., at step 460).

In some examples, each step of the method 400 may be operatively performed by the controller. In the same or other examples, the controller may be included on the work machine. Accordingly, the method 400 may be operatively performed by the work machine itself, which effectively self-manages its scheduling and power usage of the trolley network. In other examples, however, the controller may be located external to the work machine and may communicate with the work machine through the first communication module and the second communication module. In such examples, the method 400 may be operatively performed externally, e.g., by a central planner, which may or may not manage other work machines concurrently.

In step 410, a plurality of states of the work machine are monitored (e.g., by receiving status information from one or more sensors of the work machine that may include location, speed, load, or other such data), including at least a type, a state of charge of its rechargeable battery, a location, and one or more assigned tasks. The type may include the make, model, or category of machine; its prime mover; its power train; its tractive device; and yet other defining characteristics, which may impact a charging strategy for the machine. In various examples, the assigned tasks may include basic logistical information, such as a location and start time of one or more jobs, but may include additional information, such as but not limited to expected energy consumption, expected duration, expected depreciation, etc. In other examples, the plurality of states may further include a state of health of the rechargeable battery, a priority of the assigned tasks, and/or a fuel cell fuel level (if the work machine is a fuel cell electric machine), although no limitation is intended herein for the total type or number of states being monitored.

Where applicable, the above plurality of states may be relayed to the controller through the first communication module of the work machine and the second communication module of the controller, for example, through a Wi-Fi connection, Bluetooth pair, radio communication, or other technology common to the art. In various examples, the monitored states may be transferred in real-time or at predetermined intervals, depending on applicational requirements. In some examples, the states may be relayed through the trolley network 20, using the connection with the trolley network 20 to communicate with the controller and/or other work machines.

In step 430, the controller may determine a throughput rate for the trolley network. The throughput rate may be based on a number of factors such as the rate of material extraction at a mine site, rate of desired material delivery at a destination, type of work machine available, capacity of work machines, speed of work machines, consumption rate of material at a destination, and other such factors. The controller may not determine and/or manage a predicted sequence or timing of work machine arrivals. Instead, the controller may institute a policy for control such that all work machines that arrive at a trolley network 20 connect immediately to the trolley network (e.g., physically connect) without stopping or slowing. In this manner, the controller will cause work machines to continue operation rather than park up or slow down to meet a particular scheduled arrival time at a trolley entrance and/or exit.

In some examples, the trolley may be included in a production circuit for a work site with work machines 10 allocated to the production circuit such that the average flow rate through the trolley (e.g., the target number of work machines attached to the trolley at any particular time) is within a target range. The throughput rate may therefore refer to the number of work machines 10 coupled to the trolley. Accordingly, the number of work machines allocated to the production circuit may be determined based at least in part on the capacity of the trolley and/or the throughput rate determined for the trolley.

The controller may be configured to manage operations of work machines on a particular production circuit. The number of work machines assigned to the production circuit (e.g., the trolley network) may be adjusted to reach the throughput rate (e.g., at step 430). The work machines of a production circuit are assigned to meet the throughput rate for the production circuit. As required, the work machines may travel along the trolley using power drawn from the trolley network, charge a battery using the drawn power, travel under battery power while connected to the trolley, slow down or otherwise reduce energy use based on overall power consumption and/or demand at the trolley.

In a first example, a work machine may draw available energy from the trolley system to propel the work machine when connected to the trolley system and may also draw available energy to charge a battery of the work machine that may be used for operating the work machine. In the first example, the work machine may draw a first level of energy from the trolley to propel the work machine and charge the battery of the work machine. After the battery reaches a predetermined level of charge (e.g., energy storage amount) the work machine may draw a second level of energy that may be used for propelling the work machine without charging the battery. In the example, if the available energy is insufficient to provide the first level of energy and/or the second level of energy then the work machine may be propelled using battery power. In the example, the work machine may not reach a target level of charge for the battery, but may maintain the throughput of the trolley system. In some examples, the reserve energy level and/or energy level consumed may be based at least on part on a probability that the work machine may reach a minimum target charge (e.g., a lower charge threshold for the battery of the work machine 10). In some examples, the reserve energy may be adjusted for charging over a shorter period of time.

In a second example, the work machines may always draw power from the trolley to propel the work machine. In this manner, the work machines may travel slower when energy is limited across the trolley (e.g., due to an increased number of work machines being attached to the trolley). The power draw for charging may be proportional to velocity of the work machines. In the second example, the work machines may charge their batteries at a minimal rate to reach the target charge level.

In some examples, the system may determine to charge a battery of a work vehicle at a stationary charge station rather than charging on the trolley. For example, if the battery is at a level that would require diverting a significant proportion of power to the single work machine, the system may determine to send the work machine to a stationary charger rather than to consume the significant portion of energy available on the trolley. In an illustrative example, a BEM traveling along the trolley might stop to charge at a stationary charger, such as in an instance where a number work machines on the trolley may be higher than planned (e.g., above a threshold level). In this manner, the BEM moving off the trolley to charge may allow other work machines to travel along the trolley at a higher rate (e.g., potentially at a higher propulsion rate). This may allow the system to achieve separation between BEMs and/or work machines on the trolley system and thereby reduce a likelihood that the work machines will exceed the capacity of the trolley, and potentially slow the throughput rate.

In some examples, the BEM may be diverted to a stationary charge station in instances where the system determines that the BEM may have a high likelihood of needing to use battery power while traveling along the trolley. This may include the system confirming that the BEM has enough charge to make the trip along the trolley, even if it has to use battery power for some or all of the trip along the trolley. The variance in work machine flow rates may be projected and/or simulated using various simulation techniques and methods.

In some examples, the throughput rate and/or use of the work machines may depend on the type of the work machine. In an example, the work machine is a fuel cell electric machine having a rechargeable battery of relatively low capacity. According to a first strategy, the state of the charge may be easily repleted and thus take relatively low priority during the scheduling process, e.g., with respect to battery electric machines. According to a second strategy, the scheduled usage may prioritize one or more fuel electric machines based on their respective fuel cell fuel levels. In another example, the work machine is a battery electric machine being having a rechargeable battery of relatively high capacity. According to a second strategy, the state of charge of the battery, the state of health of the battery, and/or an energy efficiency of the work machine make take relatively high priority. And in yet other strategies, a high-capacity battery may receive less priority than a low-capacity battery since it offers greater reserve power. In various examples, properties of the work machine, such as battery capacity, travel speed, powertrain efficiency, and other considerations may impact the scheduling process, where no limitation is intended by the present disclosure.

In step 460, electric power is supplied from the trolley network to the work machine, and may include allocating a power draw by the work machine (e.g., at step 461) and distributing the power draw among the machine's functions (e.g., at step 462). The step of allocating (e.g., at step 461) may be measured as an instantaneous rate, e.g., in Watts, and/or as a total power draw throughout the duration of the route, e.g., in Watt-hours or Joules. Next, the power draw may be distributed (e.g., at step 462) between charging the rechargeable battery and powering the propulsion motors, e.g., driving the tractive device. As with step 430 above, a number of exemplary strategies for step 460 are also provided below. It is worth noting that the instantaneous rate and the distribution of the power draw may not be constant throughout the duration of the route.

In a first example, the power draw may be fully maximized according to the specifications of the work machine and the trolley network. In other words, the battery may be supplied a maximum allowable or safe current; the propulsion motors and the tractive device may be supplied a maximum allowable or safe current; and any intervening components, such as the contact wire, the charging apparatus, the powertrain, etc. are each operating within allowable or safe limits.

In a second example, the power draw to the rechargeable battery may be optimized and/or prioritized. In various examples, the power draw may be allocated and distributed such that the rechargeable battery is charged as quickly as possible, such that the rechargeable battery is charged as fully as possible, such that the rechargeable battery is charged at an optimal rate for battery health, and/or some combination of the above. In the same or other examples, the power draw to the tractive device may be accordingly relegated, and a speed and/or energy efficiency of the work machine may be affected.

In a third example, the power draw to the tractive device may be optimized and/or prioritized. In various examples, the power draw may be allocated and distributed such that the work machine travels as quickly as possible, such that the work machine exits the trolley network at a time congruent with its assigned tasks, such that the machine travels at an optimal speed for energy efficiency, and/or some combination of the above. In the same or other examples, the power draw to the rechargeable battery may be accordingly relegated, and a state of charge and/or a productivity of the work machine may be affected.

In a fourth example, the work machine is specifically a fuel cell machine and the power draw may be allocated based on the fuel cell fuel level. In an example, during the step of supplying electric power (e.g., at step 460), a fuel cell of the work machine may be idled. In the same or other examples, the power draw to the work machine may be distributed such that the rechargeable battery is charged during the scheduled usage; and such that the tractive device is driven via electric power from the trolley network only. In some examples, the work machine may be supplied electric power such that the rechargeable battery is fully charged during the scheduled usage.

Though the trolley infrastructure may take different forms (overhead wires, side rail, ground-based rail, etc.), the different types of structure may each include a long conductor connected to an energy source. The energy source has the capacity to provide a maximum amount of power (usually measured in megawatts) at a specified voltage. A single work machine connected to a trolley system close to the energy source, could draw up to the full power available with a minimal drop in voltage. Where more than one work machine is connected close to the energy source, each work machine would be limited to a fraction of the available power (to keep the total power drawn within the defined limit).

When a work machine is further away from the energy source, the voltage on the conductor may drop due to the resistance of the conductor. This drop in voltage limits the amount of power that individual work machines may draw. The power available to any individual work machine will be further limited according to the power drawn by all other work machines at different locations along the trolley.

The factors that determine how much power an individual machine may draw from the trolley may include the location of the energy source, the power available from the energy source, the effective resistance of the conductor, the location of the work machine, the location of other machines connected to the trolley, and/or the amount of power being drawn by other work machines on the trolley. The amount of power required to keep a work machine moving at a constant speed may be approximated by equation below.

P=Fv

Where P is average power, F is force (drag), and v is average velocity. In some respects, P may be expressed as a polynomial with components proportional to wind resistance and rolling resistance, among other factors. Since these forces expressed as higher order polynomials will cause power use to drop as velocity is reduced, they will partially offset fixed energy use (auxiliary systems).

The charge state of a battery is measured in Amp Hours (Ah) where an Amp Hour is the capacity to deliver one Amp for one hour (at a set voltage). When charging a battery, the objective of the charging by the controller is to increase the charge (Amp Hours) from a present state to a target state. The time required to charge a battery is proportional to the power (current) delivered to the battery. Since the time on the trolley is proportional to velocity, the amount of power (current) required for charging may also be varied by velocity. Where the current used for charging is proportional to velocity, a target discharge energy capacity can be achieved irrespective of the velocity (or variations in velocity) while transiting across the trolley.

Since both the power required for propulsion and the power required for charging may be varied in proportion to speed, the total power drawn by a machine on the trolley may vary with speed. In some examples, the work machines may include preconfigured settings, information, and configurations that may include information such as a unique identifier for a specific station of the trolley, a location that includes a polygon which may be used by work machines to detect entry to a specific station of the trolley, which may be the waypoint associated with the station, the origin of the polygon may represent the start of the trolley, a distance to a start or end of a trolley segment (e.g., a trolley segment including a portion of a trolley that includes a continuous contact conductor such as an overhead wire, rail, or other such conductor) that may be part of a trolley, and therefore a trolley may be powered by one or more energy sources along the trolley segments, or other such information that may be used by work machines to calculate the distance from their current location to the energy source while connected to the trolley at a particular station, in some examples, a work machine may use wheel rotations and/or odometer to calculate distance travelled while connected to the trolley, a distance penalty may include a rate at which the energy (power) allocation must be prorated according to the distance of the machine from a start or end of the trolley segment, a target or maximum speed of the work machine while on the trolley, maximum speed may be constrained by a battery charge current limit were a work machine needs to spend a defined time on the trolley to achieve its target discharge energy capacity, a minimum speed that is the minimum speed that must be maintained by work machines connected to the trolley system (e.g., where machines are unable to draw enough power from the trolley to maintain this minimum speed, they are expected to supplement the power drawn from the trolley with battery power), the length of the trolley system, and/or a target discharge energy capacity.

In some examples, full or partial network coverage is provided for a trolley system, the system may dynamically set a power allocation and target discharge energy capacity for work machines by sending the work machine a message, that may be across the network, peer to peer, or otherwise, with the message including information such as a unique identifier, a power allocation for a first segment when a work machine is located near the energy source of the trolley, a power allocation for a second segment that may be powered independently of the first segment, and/or a target discharge energy capacity that may include a minimum state of charge to be targeted while the work machine is on the trolley system. The trolley system may include two or more segments, with the example above only being illustrative of two segments.

In an example, the work machines may arrive at the trolley terminus at irregular intervals just as they do at loading tools, dumps, and other stations. Where work machines arrive less frequently than planned, all the work machines may be able to connect to the trolley system without exceeding its capacity. Work machines may even be able to travel and charge faster when the trolley is running below its planned capacity.

In an example, the work machines may arrive at the trolley terminus more frequently than planned and/or the work machines may not be able to connect to the trolley at planned power levels without exceeding the capacity of the trolley. The controller may be configured to maintain a planned throughput and therefore the controller may allow more work machines to connect to the trolley and to travel at a slower speed. The controller may vary the power required for propulsion and charging in proportion to velocity of the work machines, it is possible to achieve the same throughput (or similar throughput) by allocating more work machines onto the trolley at a slower speed.

In this example, the controller may manage the speed and total power drawn by each work machine connected to the trolley to maintain the planned throughput. In some examples, where less work machines arrive at the trolley Infrastructure than planned, the work machines may each run faster and draw more power from the trolley. Where more work machines arrive at the trolley, they may each run slower and draw less power. The objective of the controller may be to manage the speed and power drawn by each work machine on the trolley so that the planned throughput for the trolley (or Production Circuits) is maintained without exceeding the capacity of the trolley. The throughput limit for the trolley system may be calculated by observing the energy used by work machines travelling at the target speed defined for the trolley. This limit may be the average energy used by the work machine including fixed energy use, linear energy use, polynomial energy use, and energy used for charging.

And in other examples, some or all of the above considerations, and yet other possible considerations, may be used in combination when supplying, allocating, and distributing electric power to the work machine. In an example, the method 400 may further comprise optimizing, for one or more predetermined criteria, usage of the trolley network, during the course of the machine's assigned tasks, or even throughout the lifespan of the work machine (step 420). The criteria may include, among other possibilities, an energy efficiency of the work machine, such as a fuel efficiency or a cost of travel; a productivity of the work machine, e.g., as measured in widgets produced, freight transported, machine uptime, or other common units; and a depreciation of the work machine, such as a reduction in the state of health of the rechargeable battery.

In some examples, the controller may reallocate power and/or distribute electric power to the work machines based on an energy level, for example to increase power delivered to a work machine with a low battery charge. In some examples, the controller may distribute the available power across all connected machines to reduce energy throughput by reducing use of battery power while connected (e.g., to reduce battery damage). In some examples, the controller may use a combination of trolley and battery power to keep the work machines moving as fast as possible and therefore maximize productivity.

In the same or other examples, the method 400 may further comprise optimizing for a reward function. The reward function may balance various considerations such as battery charge level, work machine speed, power availability, and other such factors to be used for determining power allocation across the system. For example, the reward function may assign a value to each of the above considerations, including but not limited to energy efficiency, productivity, adherence to throughput rate, adherence to flow rate, and depreciation, and may consider other factors germane to the goals of the mine site. In various examples, the reward function may be predetermined, may be programmed by a human operator, and/or may be set according to specific applicational requirements. And in other examples, the reward function may be based on a machine learning algorithm, such as one employing reinforcement learning, supervised learning, or unsupervised learning techniques, which may or may not be updated in real-time.

In some examples, the method 400 may further comprise navigating the work machine to an entry point of the trolley network (e.g., at step 440) and/or connecting the work machine and, more specifically, the charging apparatus, to the trolley network (e.g., at step 450). In the same or other examples, the controller may utilize the location of the work machine to provide navigational instructions toward an entry point of the trolley network.

Turning now to FIG. 5, a method 500 of charging a fleet of work machines via a trolley network is depicted. As seen in FIG. 5, the method 500 may comprise monitoring a plurality of states of the fleet (e.g., at step 510); monitoring a plurality of states of the trolley network (e.g., at step 520); determining throughput for the trolley network (e.g., at step 540); and supplying electric power from the trolley network to the connected work machines in accordance with maintaining the throughput for the trolley network (e.g., at step 570). It may be appreciated that the method 500 is related to the method 400 in several ways, but may include additional strategies to accommodate for scheduling and charging multiple work machines concurrently.

In some examples, each step of the method 500 may be operatively performed by the fleet controller. It should be noted that, while the method 400 may be operatively performed by the machine itself (e.g., the controller is included on the work machine), the method 500 may require an external fleet controller in bi-directional communication with each machine within the fleet. In various examples, the fleet controller may be located in a management station, may be located on the trolley network, may be located on a distributed computer, may be located on a single work machine within the fleet, and yet other possibilities. In some examples, the method 500 may be performed by a computing device of a work machine in communication using a peer-to-peer communication with other work machines to control the operations of the system.

In step 510, a plurality of states of the fleet are monitored, including at least a type of each work machine, a state of each rechargeable battery, a location of each work machine, and one or more assigned tasks of each work machine. In some examples, the plurality of states of the fleet may further include a state of health of each rechargeable battery, a priority of each assigned task, a fuel cell fuel level (if the machine is a fuel cell electric machine), and other possible states, where no limitations are intended herein. Furthermore, unlike step 410 in the method 400, step 510 may further include aggregated states of the fleet, such as global average or global total states of charge, global average states of health, global average fuel cell fuel levels, roster requirements for assigned tasks, and other possibilities.

In step 520, a plurality of states of the trolley network are monitored, including a maximum power output from the trolley network, a count of the connected work machines, and a power draw of each connected work machine. Consequently, the instantaneous power output from the trolley network and/or a saturation of the trolley network may also be known and monitored. In some examples, the plurality of states of the trolley network may further include a speed of each connected work machine, an expected duration of travel, and yet other possibilities.

The plurality of states may be relayed to the fleet controller through the first communication module of each work machine, the second communication module of the trolley controller, and a communication module of the trolley network. In various examples, the monitored states of both the fleet and the trolley network may be transferred in real-time or at predetermined intervals, depending on specific applicational requirements.

In step 540, one or more work machines are configured to maintain a determined throughput for the trolley network. In some examples, the throughput may be determined based on a flow rate, number of machines, and/or other conditions described herein including a speed of travel throughout the route for each machine. The throughput for the trolley network may be based on the plurality of states of the fleet and the network, and may further include prioritizing one or more work machines (step 541) and relegating one or more work machines (step 542) for example if a battery status or maintenance status is indicative of needing to be taken out of a production circuit and/or reassigned to a different production circuit.

In an example, one or more work machines may be prioritized in the scheduling queue based on each machine's state of charge. In an example, a work machine with a battery near depletion may be scheduled for immediate charging on the trolley, and/or one or more work machines with the lowest states of charge may be prioritized for relegation to a charging station away from the production circuit. In the same or other examples, the priority may be proportional to each machine's state of charge, may be a function of each machine's state of charge, and/or may factor in an expected rate of energy consumption along the trolley. In some examples, one or more work machines may be relegated or de-prioritized for charging (e.g., indicating that the work machine is lower in priority or need for charging than other work machines) based on their (relatively) full states of charge.

In some examples, the system may determine to charge a battery of a work vehicle at a stationary charge station rather than charging on the trolley. For example, if the battery is at a level that would require diverting a significant proportion of power to the single work machine, the system may determine to send the work machine to a stationary charger rather than to consume the significant portion of energy available on the trolley. In an illustrative example, a BEM traveling along the trolley might stop to charge at a stationary charger, such as in an instance where a number work machines on the trolley may be higher than planned (e.g., above a threshold level). In this manner, the BEM moving off the trolley to charge may allow other work machines to travel along the trolley at a higher rate (e.g., potentially at a higher propulsion rate). This may allow the system to achieve separation between BEMs and/or work machines on the trolley system and thereby reduce a likelihood that the work machines will exceed the capacity of the trolley, and potentially slow the throughput rate.

In some examples, the BEM may be diverted to a stationary charge station in instances where the system determines that the BEM may have a high likelihood of needing to use battery power while traveling along the trolley. This may include the system confirming that the BEM has enough charge to make the trip along the trolley, even if it has to use battery power for some or all of the trip along the trolley. The variance in work machine flow rates may be projected and/or simulated using various simulation techniques and methods.

The throughput for the system may further depend on the type of each work machine, whose characteristic fuel type, powertrain, tractive device, battery capacity, travel speed, and other factors may impact the scheduling process. In another example, one or more work machines may be prioritized for charging on the trolley system based on each machine's fuel cell fuel level, where applicable. And in other examples, some or all of the above considerations, and yet other possible considerations, may be used in combination in order to determine the throughput for the trolley network, where no limitation is intended herein.

As one or more work machines may be prioritized for charging, one or more work machines may necessarily be relegated as well. In addition to the examples discussed above, one or more work machines may be relegated, in effect, based on the states of the trolley network. In an example, one or more work machines may be relegated based on the saturation of the trolley network.

In another example, the step of determining the throughput of the trolley network (e.g., at step 540) may further include a consideration for avoiding congestion of the trolley network. In an example, one or more work machines may be prioritized and/or configured such that work machines travel through the trolley at or near the same speed by configuring power delivery to one or more machines to adjust the speed based on power delivery to each work machine.

In step 570, electric power is supplied from the trolley network to the connected work machines, including allocating a power draw by each connected work machine (step 571) and distributing each power draw between charging the rechargeable battery and powering the propulsion motors, e.g., driving the tractive device, of each work machine (e.g., at step 572). A number of exemplary strategies for step 570 are provided below.

In a first example, the trolley network may be capable of supplying a maximum power draw to each connected work machine. In other words, for each connected work machine, the battery may be charged at a maximum allowable or safe current; the propulsion motors and the tractive device may be powered at a maximum allowable or safe current; and any intervening components are also operating within their allowable or safe limits, respectively.

However, in the following examples, the trolley network may not be capable of supplying the maximum power draw to each connected work machine. Accordingly, the power draw may need to be allocated among the connected work machines, and may be portioned according to a number of different strategies.

In a second example, power may be allocated to the one or more connected work machines based on a function of the battery capacity or the state of charge of each work machine. In various examples, each connected work machine may be supplied power proportional to its maximum power draw; each work machine may be supplied an equal share of the maximum power output of the trolley network; each work machine may be supplied electric power as a function of its battery capacity; and/or each work machine may be supplied electric power as a function of its state of charge.

In a third example, power may be allocated to the one or more connected work machines based on the assigned tasks and/or the priority of the assigned tasks of each work machine. In various examples, each connected work machine may be supplied power equal to or proportional to the needs of its assigned tasks; each connected work machine may be supplied power required to timely travel to the next assigned task; and/or each connected work machine may be supplied electric power as a function of the immediacy and/or the priority of its assigned tasks. In an example, each connected work machine may also be allocated power based on the roster requirement of its assigned tasks. For example, one or more work machines having a shared assignment may be allocated an equivalent power draw, or may be allocated a power draw proportional to its battery capacity or its role within the shared assignment.

In a fourth example, power may be allocated to one or more connected work machines based on the fuel cell fuel level of each work machine (if the machine is a fuel cell electric machine). In this manner, a fuel cell (or other work machine such as a diesel electric machine) may draw a portion of trolley power to propel the work machine and reduce fuel use when connected to the trolley. This may reduce emissions by the system overall.

It may be appreciated that the power draw allocated to each connected work machine may change as one or more work machines connect to or disconnect from the trolley network. In an example, a saturated trolley network may accommodate another work machine by reducing the power draw to each presented connected work machine. Conversely, when a work machine exits the trolley network, the power draw allocated to the remaining connected work machines may be reallocated and/or increased. In various examples, the power draw to each connected work machine may be reapportioned in real-time, at predetermined intervals, or when key events occur, such as when a work machine connects to or disconnects from the network.

In addition to allocating the power draw to each connected work machine, step 570 may include distributing the power draw by each work machine between charging the rechargeable battery and driving the tractive device (e.g., at step 572), for which a number of exemplary strategies are also provided below.

In a fourth example, the distribution of power draws to one or more connected work machines may prioritize charging the rechargeable battery. In various examples, the power draw may be distributed: such that a single connected work machine is fully charged; such that multiple connected work machines are fully charge; such that each connected work machine is equally or equitably charged; and/or such that each connected work machine is charged as a function of its assigned tasks or as a function of the priority of its assigned tasks.

In a fifth example, the distribution of power draws to one or more connected work machines may prioritize driving the tractive device. In various examples, the power draw may be distributed: such a single work machine travels at a maximum speed; such that multiple machines travel at a maximum speed; such that each connected work machine travels at an equal or equitable speed; such that the sum travel time is minimized; such that a productivity of the fleet is maximized; such that each connected machine exits the trolley at a reasonable time relative to the start time of its assigned tasks; and/or such that each connected machine travels at an optimal speed for energy efficiency.

In a sixth example, the distribution of power draws to one or more connected work machines may prioritize the state of health of the rechargeable battery and/or a depreciation of the work machine. In various examples, the power draw may be distributed: such that a single machine is charged at an optimal rate for battery health; such that each connected work machine is charged at an optimal rate for battery health; such that a single connected work machine travels at an optimal speed for machine depreciation; and/or such that each connected work machine travels at an optimal speed for machine depreciation. In some examples, the power draw may be distributed such that the state of charge of each rechargeable battery remains within an acceptable range. The acceptable range may vary according to the work machine and may, for example, have a lower bound of 5%, 10%, 15% or 20% of the total battery capacity and an upper bound of 80%, 85%, 90% or 95% of the total battery capacity.

In a seventh example, one or more work machines of the fleet are specifically fuel cell electric machines. In such circumstances, their fuel cells may be idled or shut-off when the work machine is connected to the trolley network. In an example, the power draw may be distributed such that the rechargeable battery is charged (which may require relatively low power), and the remaining power draw is distributed toward driving the tractive device. In some examples, the work machine may be supplied electric power such that the rechargeable battery is fully charged during the connection with the trolley.

And in other examples, some or all of the above considerations, and yet other possible considerations, may be used in combination when allocating and distributing electric power to the connected work machines.

In some examples, the step of supplying electric power (e.g., at step 570) may further include a consideration for avoiding congestion of the trolley network. For example, one or more work machines may be allocated and distributed power such that their travel along the trolley is sufficiently spaced to not cause a bunching of work machines along the route.

In some examples, a connected work machine may be rejected from the trolley network during the middle of the route. Accordingly, the method 500 may comprise a step of adjusting the allocated power draw to the other connected work machines. Where the trolley network comprises a single-lane route, the adjustment of power draw allocation may consider the new speed of the rejected work machine. For example, the power draw distributed to the remaining, connected work machines may be adjusted in order to match the speed of the rejected work machine. In other examples, the trolley network may comprise a multi-lane route. Accordingly, the power draw by the rejected work machine may be reallocated to the remaining, connected work machines. However, the speed of the remaining, connected work machines, and the distribution of power draw to their tractive device, may be unaffected.

In an example, the method 500 may further comprise optimizing for one or more predetermined criteria along the trolley network, during the course of fleet's assigned tasks, or even throughout the lifespan of the entire fleet (step 530). The criteria may include, among other possibilities, an energy efficiency of the fleet; a productivity of the fleet; and a depreciation of the fleet. In the same or other examples, the method 500 may further comprise optimizing for a reward function. For example, the reward function may assign a value to each of the above considerations, including but not limited to energy efficiency, productivity, and depreciation, and may further assign values to individual work machines and/or the fleet as a whole. The reward function may be predetermined, may be programmed by a human operator, and/or may be set according to specific applicational requirements. And in other examples, the reward function may be based on a machine learning algorithm, such as one employing reinforcement learning, supervised learning, or unsupervised learning techniques, which may or may not be updated in real-time.

In some examples, the method 500 may further comprise navigating one or more work machines to one or more entry points of the trolley network (e.g., step 550) and/or connecting one or more work machines and, more specifically, each machine's charging apparatus, to the trolley network (e.g., step 560). In the same or other examples, the fleet controller may utilize the location of the work machine to provide navigational instructions toward an entry point of the trolley network.

While the preceding text sets forth a disclosure of numerous different examples, it should be understood that the legal scope of protection is defined by the words of the claims set forth at the end of this patent. The disclosure is to be construed as exemplary only and does not describe every possible example since describing every possible example would be impractical, if not impossible. Numerous alternative examples could be implemented, using either current technology or technology developed after the filing date of this patent, which would still fall within the scope of the claims defining the scope of protection.

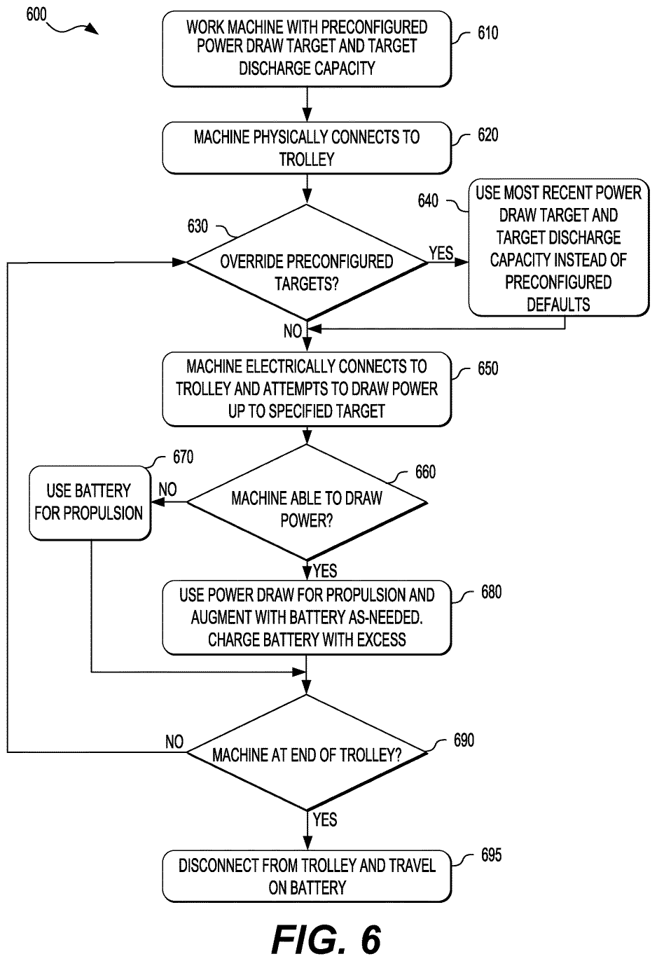

Turning now to FIG. 6 illustrates a flowchart depicting a method 600 for controlling power delivery and usage for a fleet of work machines via a trolley network, according to at least one example. In some examples, each step of the method 600 may be operatively performed by the controller. It should be noted that, while the method 600 may be operatively performed by the machine itself (e.g., the controller is included on the work machine), the method 600 may require an external fleet controller in bi-directional communication with each machine within the fleet. In various examples, the fleet controller may be located in a management station, may be located on the trolley network, may be located on a distributed computer, may be located on a single work machine within the fleet, and yet other possibilities. In some examples, the method 600 may be performed by a computing device of a work machine in communication using a peer-to-peer communication with other work machines to control the operations of the system.

The method 600 may include a work machine beginning with a preconfigured power draw target and target discharge capacity at step 610. The preconfigured power draw target and the target discharge capacity may be configured to cause the work machine to travel at a preconfigured speed along the trolley according to a preconfigured throughput rate. The target discharge capacity of the battery may be configured to enable the work machine to meet the throughput rate and may also be configured to balance use of the battery against other considerations including battery health and other such factors.

The method 600 may include the work machine physically connecting to the trolley at step 620. The work machine may physically connect to the trolley using a physical connector. At step 630, the method 600 may include determining whether or not to override the preconfigured targets for the work machine. The determination to override the targets may be based on power availability of the trolley, power draw for the work machine, and the number of work machines attached to the trolley. In the event that the controller determines to override (e.g., to provide power to change the speed and/or other power draw for each machine) the targets, then the controller may use a most recent power draw target and target discharge capacity at step 640 instead of the preconfigured defaults. The controller may then proceed to electrically connect to the trolley (e.g., which may be separate from the physical connection) and attempt to draw power up to the target. In the event that the preconfigured targets are not overridden then the method may proceed directly to step 650.

The controller and/or system may determine, at step 660, if the work machine is able to draw power based on the configuration. In the event that the machine is not able to draw the required power, the machine may use the battery for propulsion at step 670. In the event that the system is able to draw the power required, the process proceeds to step 680 and the system and/or machine may use the power draw for propulsion and may augment with the battery as-needed. Excess power may be used to charge the battery of the work machine. At step 690, the method 600 may include determining if the work machine has reached the end of the trolley. In the event that the work machine has not reached the end of the trolley, the method may return to step 630 and determine whether to change the power delivery targets before reaching the end of the trolley. The method 600 includes disconnecting physically and electrically from the trolley at step 695 when the work machine reaches the end of the trolley. The work machine may then proceed using the battery of the work machine along the production circuit.

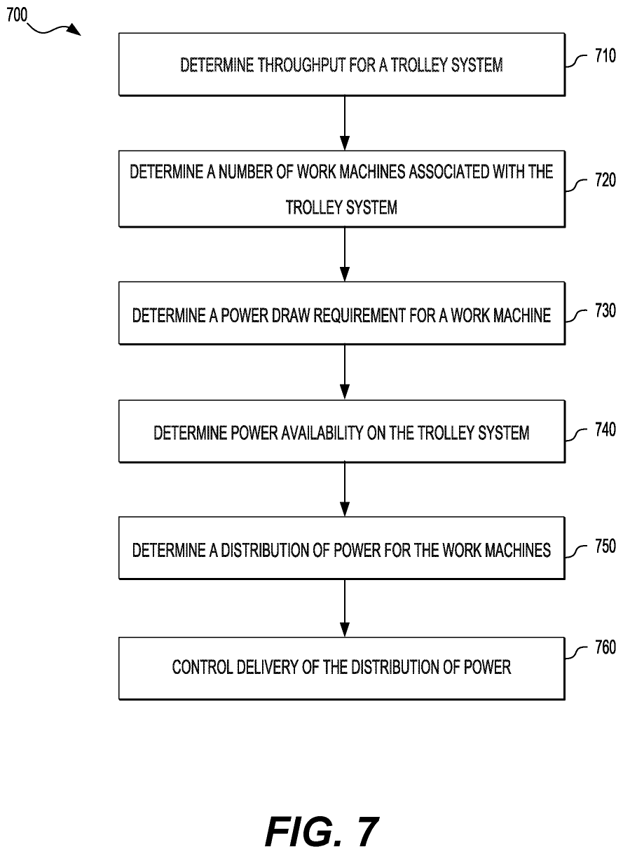

FIG. 7 illustrates a flowchart depicting a method 700 for controlling power delivery to one or more work machines and sharing available power to maintain a throughput rate of the trolley network, according to at least one example. In some examples, each step of the method 700 may be operatively performed by the controller. It should be noted that, while the method 700 may be operatively performed by the machine itself (e.g., the controller is included on the work machine), the method 700 may require an external fleet controller in bi-directional communication with each machine within the fleet. In various examples, the fleet controller may be located in a management station, may be located on the trolley network, may be located on a distributed computer, may be located on a single work machine within the fleet, and yet other possibilities. In some examples, the method 700 may be performed by a computing device of a work machine in communication using a peer-to-peer communication with other work machines to control the operations of the system.

The method 700 may begin at step 710 with the controller, system, or other device determining throughput for a trolley system. The trolley system may have a throughput as described herein including a rate of work machines and/or material flow rate and/or other rate of delivery of items and/or materials along the trolley system. The throughput for the trolley system may be input and/or determined and provided to the system. The method 700 may further include determining a number of work machines associated with the trolley system at step 720. The number of work machines may include a number of work machines on a production circuit and may include a number of work machines allocated to the system based at least in part on work machine availability, throughput rate, production tasks specified by a planning system, or other factors such as described herein.

The method 700 may include determining a power draw requirement for a work machine at step 730. The power draw requirement may include power to drive the work machine (e.g., to drive a tractive system) as well as power to charge a battery of the work system. The power draw requirement may be determined based on the speed for the work machine, which may be determined based on the number of work machines and also the throughput rate for the trolley system. The power draw requirement may also be based on the battery charge status of a rechargeable battery of the work machine. The method 700 also includes determining power availability on the trolley system at step 740. The power availability may be based on the number of work machines, the power drawn by the work machines, the power source, and other such factors. The power availability may be determined based on communication between the work machines and the controller and/or between the work machines and each other.

The method 700 further includes determining a distribution of power for the work machines at step 750. The distribution of power may include a first portion of power configured to drive the propulsion devices of the work machines and a second portion of power configured to charge the rechargeable batteries of the work machines. The distribution of power may be determined based on power needs and/or availability of power on the trolley. The distribution of power may be based on communications with a controller and/or peer-to-peer communications between work machines as described herein.

The method 700 may include controlling delivery of the distribution of power to the work machines at step 760 based on the distribution of power determined at step 750. In some examples, the delivery of the power to the work machines may be based on the charge statuses of the rechargeable batteries of the work machines, the energy to drive the propulsion devices, and the energy needed and/or drawn by other work machines.

FIG. 8 illustrates an operational environment 800 of a DET system 802, according to an embodiment. Operational environment 800 comprises one or a plurality of movement pathways 804 (e.g., haul road(s) or other paved or unpaved road(s), railroad track(s), water canal, etc.), along which one or a plurality of machines 806 travel. Operational environment 100 may include an environment in which one or a plurality of machines 806 perform a task associated within an industry, such as mining, construction, transportation, energy exploration, farming, or the like. For example, operational environment 800 could include one or more mine sites in which a plurality of machines 806 cooperate to perform tasks associated with mining, using a plurality of movement pathways 804 to haul material between various locations within the mine site. However, it should be understood that disclosed embodiments are not limited to any particular environment.

Machine 806 may be an electric vehicle that uses one or more electric motors (e.g., as opposed to a combustion engine) for propulsion. Each machine 806 may comprise an on-board battery system that comprises one or more rechargeable batteries configured to supply power to the electric motor(s) of machine 806. Alternatively, instead of a battery-powered machine, machine 806 could be a diesel-powered machine, a fuel-cell-powered machine, a hybrid machine (e.g., powered by both diesel and an on-board battery system), or the like. While machine 806 is illustrated as a dump truck, it should be understood that machine 806 may be any type of equipment, including a wheel loader, asphalt paver, backhoe loader, skid steer, track loader, cold planer, compactor, dozer, electric rope shovel, excavator, forest machine, hydraulic mining shovel, material handler, motor grader, pipe-layer, road reclaimer, telehandler, tractor-scraper, or the like, as well as ordinary road vehicles (e.g., automobiles, semi-trucks, etc.) or marine vessels (e.g., tug boat, ship, etc.).

DET system 802 may be installed along one or more movement pathways 806 within operational environment 800. For example, DET system 802 may be installed along one or both sides of movement pathway(s) 804. DET system 802 may comprise a plurality of poles 808 as the conductor support infrastructure. Poles 808 may be spaced apart along the side of a movement pathway 804 at substantially equidistant intervals (e.g., approximately 6 meter intervals). Rail segments 810 may be mounted on top of poles 808 and connected to each other using fasteners, referred to herein as “fishplates,” to form a continuous rail that is elevated off the ground.

In an embodiment, rail segments 810 are conductive. The rail, formed by a plurality of rail segments 810, may be electrically connected to a power supply (e.g., the distribution network of a power grid or microgrid), such that electricity flows through the rail. Machine 806 may comprise an arm 812 that extends from a side of machine 806. A receiver 814 at the end of arm 812 contacts the rail formed by rail segments 810. Arm 812 and receiver 814 form a conductive path from the contact end of receiver 814 to the on-board battery system of machine 806. Arm 812 and receiver 814 are configured to allow for some level of imperfection or variation in the contact region between receiver 814 and the rail. Thus, as machine 806 travels along a movement pathway 804, with receiver 814 contacting the rail, electricity from the conductive rail flows through receiver 814 and arm 812 to charge the on-board battery system of machine 806, which powers the motor(s) of machine 806. Consequently, machine 806 is charged while moving through operational environment 800.

The length of poles 808 may be configured to elevate rail segments 810 to a safe height above the ground. A safe height may be a height that most humans (e.g., 99% of humans based on average reach) are unable to reach without assistance. For example, the rail may be elevated at least 3 meters above the ground. This prevents workers within the operational environment 800 from accidentally touching the rail, thereby reducing the likelihood of electrocution and improving safety. It should be understood that poles 808 may be set within the ground, such that the length of each pole should be defined to include both a safe height above the ground and the height of the pole 808 that extends into the ground. One end of each pole 808 may be seated within a hole in the ground, such as a ground screw, while the other end of each pole 808 supports one or more rail segments 810. Alternatively, one end of each pole 808 may be fixed within a weighted footing (e.g., concrete barrier), while the other end of each pole 808 supports one or more rail segments 810.

For enhanced flexibility and safety, the rail may comprise three parallel rails, with each parallel rail formed from a plurality of connected rail segments 810. One outer rail may carry a positive charge, the opposite outer rail may carry a negative charge, and the center rail may be grounded. The grounded center rail enables low fault current and provides the flexibility to have different voltage levels. In addition, in the event of a collision with DET system 802 (e.g., a collision between machine 806 and DET system 802), chances are that the center rail will be included in the circuit, to thereby prevent electrocution of workers involved in or responding to the collision.

### Industrial Applicability

The present disclosure may find industrial applicability toward work machines and their associated charging networks, and may be particularly useful toward fleets of zero-emission work machines, diesel electric work machines, fuel cell machines, and other such machines that may be powered and/or charged by a trolley network. The systems and methods described herein may provide energy efficiency as well as reduced emissions.

For example, the present disclosure may be applied to a work machine, such as a large mining truck, excavator, backhoe, bulldozer, grader, trencher, tractor, front loader, and yet other possibilities. The work machine may specifically be a electric or partial electric drive machine, such as one being powered exclusively by electric batteries, diesel electric machines, or hydrogen fuel cells. The work machine may operate independently, e.g., may self-manage its power usage of the trolley network; or the work machine may be centrally managed, e.g., by the controller.

Moreover, the present disclosure may be applied to a fleet of zero-emission work machines. For example, a plurality of work machines may be employed collectively on an open-pit mine, a road construction work zone, a farm or ranch, and yet other possible work sites. The fleet may include a plurality of zero-emission work machines being supplied electric power through the trolley network. Moreover, the present disclosure may be applied to a fleet which includes zero-emission machines, diesel-electric machines, and other machines capable of being supplied electric power through a trolley network. Advantageously, an existing management system for a fleet of diesel and diesel electric machines may be modified with the systems and methods disclosed herein to include zero-emission machines such as battery electric machines and fuel cell machines.

Finally, the present disclosure may be applied to a trolley network, such as one employing overhead wires, ground-level power supplies, non-contact conductors or in-road inductive charging, railway electrification technologies, and yet other possible forms of live-electricity transfer. The trolley network may be powered through independent power generation mechanisms, and/or may transfer electric power from external sources.

Advantageously, the present disclosure may enable an optimized power usage of the trolley network by a single work machine and/or by the plurality of work machines; and may improve a productivity, an energy efficiency, and a longevity of each machine, one or more work machines, and/or the fleet as a whole.

First, the presently disclosed systems and methods may improve the productivity of a single work machine. By managing the supply of electric power through the trolley network, a work machine may reduce a quantity of time spent at charging stations, may increase an operating range, and may increase an operating uptime. The productivity of the work machine may further be improved by supplementing electrical power to the tractive device, thereby increasing the machine's travel speed and reducing a travel time between tasks.

Next, the presently disclosed systems and methods may improve the energy efficiency of a single work machine. Electric power supplied directly from the trolley network to the propulsion motors may avoid inefficiencies stemming from charging or discharging the battery, powertrain energy conversion, heat loss, etc. Moreover, electric power supplied by the trolley network may offer economies of scale and may be transported at advantageous ratings with regard to power loss. Finally, where fuel cell electric machines are concerned, consumption of electricity through the trolley network may be substantially cheaper than consumption of hydrogen fuel, and may provide increased range between refueling.

Further, the presently disclosed systems and methods may improve the battery health and/or longevity of a single work machine. The power usage of the trolley network may be managed such that the machine's battery remains within healthy state of charge limits, such that the battery is charged or discharged at favorable rates, such that the battery is operated within safe temperature ranges, and/or such that a lifetime number of charging cycles is reduced. With regard to component life, the work machine may be directed to travel at favorable speeds and/or may reduce powertrain usage when connected to the trolley network. Finally, where fuel cell electric machines are concerned, the fuel cell may be powered-off or idled when the machine is connected to the trolley network, further lengthening component longevity.

The present disclosure may extend each of the above advantages toward a plurality of work machines or an entire fleet of work machines. By following the various methods disclosed herein, the fleet and trolley system can optimize for a productivity, an efficiency, and/or a longevity of a single work machine, of one or more work machines, or of the entire fleet as a whole. Individual work machines within the fleet may be prioritized, such as by receiving greater allocations of power to their batteries or to their tractive device.

Finally, the present disclosure may improve the logistical operations of the fleet and the trolley network. By managing the distribution and speed of work machines and their speed of travel across the trolley network, the present disclosure may reduce ‘congestion’ or bunching along the route of the trolley network, may better align the schedule of each machine with its assigned tasks, may guarantee that each machine is sufficiently charged for its assigned tasks, may improve collaboration between machines having shared tasks, may stabilize the power output or saturation of the trolley network, and yet other possibilities.

1. A system comprising:
a trolley network configured to connect to and supply electric power to at least one work machine configured to couple to and selectively draw electric power from the trolley network, the at least one work machine including at least one rechargeable battery; and
a controller in operative communication with the at least one work machine, the controller configured to:
determine a required throughput rate for the at least one work machine on the trolley network;
determine a power requirement by the at least one work machine based at least in part on the required throughput rate;
determine a power balance for the at least one work machine describing a first portion of power to draw from the trolley network and a second portion of power to draw from the at least one rechargeable battery;
determine a distribution of the power requirement between charging of the at least one rechargeable battery and powering one or more propulsion devices of the at least one work machine based at least in part on the power requirement; and
cause the trolley network to control delivery of the distribution of power via the trolley network and the rechargeable battery.

2. The system of claim 1, wherein the controller is configured to determine the required throughput rate for the at least one work machine along the trolley network based at least in part on a material flow rate for the trolley network.

3. The system of claim 1, wherein the at least one work machine is configured to couple to the trolley network through a trolley interface apparatus, and wherein the controller is configured to determine the distribution of the power requirement by determining a first portion of the power requirement to provide to the one or more propulsion devices and a second portion of the power requirement to provide for charging the at least one rechargeable battery.

4. The system of claim 1, wherein the controller is configured to determine the distribution of the power requirement by determining a first power distribution between the at least one work machine and a second work machine connected to the trolley network and the work machine.

5. The system of claim 4, wherein the first power distribution comprises a first portion of electric power provided to the at least one work machine, and a second portion of power provided to the second work machine.

6. The system of claim 5, wherein the controller is configured to determine the distribution of the power requirement by determining the first portion and the second portion based at least in part on a battery status of the at least one rechargeable battery and a battery status of a second rechargeable battery of the second work machine.

7. The system of claim 5, wherein the controller is configured to determine the distribution of the power requirement by:
determining a first power requirement of the at least one work machine based at least in part on the required throughput rate;
determining a second power requirement of the second work machine based at least in part on the required throughput rate; and
determining the first portion and the second portion based at least in part on the first power requirement and the second power requirement.

8. The system of claim 1, wherein the trolley network includes:
a conductive rail segment supported by poles and configured to supply electric power through the conductive rail segment; and
a receiver coupled to the at least one work machine extending on an arm from a lateral side of the at least one work machine, the receiver configured to electrically couple the at least one work machine to the conductive rail segment.

9. A method comprising;
determining, by a controller, a throughput rate for a trolley system, the trolley system comprising:
a plurality of work machines;
a plurality of terminals along a route for the plurality of work machines;
a contact line for providing electrical power to the plurality of work machines;
determining, by the controller, a number of work machines connected to the trolley system;
determining, by the controller, a power requirement for a first work machine based at least in part on the throughput rate;
determining, by the controller, a power availability on the trolley system for providing to the plurality of work machines;
determining, by the controller, a distribution of power for the plurality of work machines based at least in part on the power requirement for the first work machine; and
controlling, by the controller, delivery of the distribution of power through the plurality of terminals and the contact line.

10. The method of claim 9, wherein determining the distribution of power for the plurality of work machines comprises:
determining, by the controller, battery statuses for the plurality of work machines;
determining, by the controller, power requirements for driving the work machines along the trolley system; and
determining, by the controller, the distribution of power based at least in part on balancing the battery statuses and power requirements to maintain the throughput rate.

11. The method of claim 10, wherein determining the distribution of power comprises:
determining, by the controller, a first portion of power to provide for driving a motor of a work machine;
determining, by the controller, a second portion of power to provide for charging a rechargeable battery of the work machine; and
distributing, by the controller, power to the plurality of work machines based at least in part on the first portion and the second portion.

12. The method of claim 11, wherein the controller determines the first and second portions based at least in part on electric power available on the trolley system or a determined voltage level on the trolley system.

13. The method of claim 9, wherein determining the distribution of power for the plurality of work machines further comprises determining, by the controller and based at least in part on the number of work machines and the power draw requirement, a machine level distribution describing allocation of the power availability across the plurality of work machines.

14. The method of claim 13, wherein:
determining the machine level distribution is based at least in part on communications between one or more of the plurality of work machines comprising at least one of power draw requirements and battery status for the one or more of the plurality of work machines; and
controlling delivery of the distribution of power is based at least in part on the machine level distribution.

15. The method of claim 13, wherein determining the machine level distribution is further based at least in part on the throughput rate.

16. A system for managing work machines, the system comprising:
a trolley network configured to connect to and supply electric power to one or more work machines, the trolley network configured to enable a physical connection and an electrical connection to the one or more work machines;
a controller in operative communication with the one or more work machines, the controller comprising:
one or more processors; and
one or more non-transitory computer-readable media having instructions stored thereon that, when executed by the one or more processors, cause the one or more processors to:
determine a required throughput rate for the one or more work machines on the trolley network;
determine a number of work machines physically coupled to the trolley network;
determine power requirements for the one or more work machines;
determine power availability on the trolley network;
determine a distribution of power to the one or more work machines based at least in part on the power requirements, the power availability, and stored power available in rechargeable batteries of the one or more work machines; and
control delivery of the distribution of power via the trolley network and the rechargeable batteries.

17. The system of claim 16, wherein the instructions to determine the distribution of power for the one or more work machines comprise further instructions to cause the one or more processors to:
determine battery statuses for the rechargeable batteries of the one or more work machines;
determine power requirements for powering the one or more work machines on the trolley network; and
determine the distribution of power based at least in part on a power balance for the one or more work machines describing a first portion of power to draw from the trolley network and a second portion of power to draw from the rechargeable batteries.

18. The system of claim 16, wherein the instructions to determine the distribution of power comprise further instructions to cause the one or more processors to:
determine a first portion of power to provide for driving motors of the one or more work machines;
determine a second portion of power to provide for charging the rechargeable batteries of the one or more work machines; and
distribute power to the work machines based at least in part on the first portion and the second portion.

19. The system of claim 16, wherein the instructions to determine the distribution of power for the work machines further comprise further instructions to determine, based at least in part on the number of work machines and the power requirement, a machine level distribution describing allocation of the power availability across the one or more work machines.

20. The system of claim 19, wherein:
the machine level distribution is based at least in part on communications between the one or more work machines comprising at least one of power requirements and battery status information for the one or more of the work machines; and
delivery of the distribution of power is based at least in part on the machine level distribution.
